(19) United States
(12) Patent Application Publication
(10) Pub. No.: US 2002/0080110 A1
(43) Pub. Date: Jun. 27, 2002

(54) Liquid crystal display having gate driving signal line in panel and correction circuit

(76) Inventors: Ha Sook Kim, Kyoungki-do (KR); Gyo Un Choi, Seoul (KR)

Correspondence Address: LADAS & PARRY, 224 SOUTH MICHIGAN AVENUE, SUITE 1200, CHICAGO, IL, 60604, US

(21) Appl. No.: 10/034,821

(22) Filed: Dec. 27, 2001

(30) Foreign Application Priority Data
Dec. 27, 2000 (KR) 2000-83246

(51) Int. Cl. G09G 3/36

(52) U.S. Cl. 345/99

(57) ABSTRACT

A liquid crystal display having a signal line for driving gate driver IC in panel is provided. The liquid crystal display comprises: a gate driving power supply unit for supplying analog signals; a control circuit unit for applying control signal to analog signal outputted from the gate driving power supply unit; a correction circuit unit for applying control signal from the control circuit unit to correct analog signal outputted from the gate driving power supply unit into a saw type; and a corrected power supply unit for supplying saw type signals corrected in the correction circuit unit to the gate driver IC.

### BACKGROUND OF THE INVENTION

1. Field of the Invention

The present invention relates generally to a liquid crystal display and, more particularly, to a liquid crystal display having a signal line for driving a gate driver IC in panel and a correction circuit for correcting gate driving power supply.

2. Description of the Prior Art

As well known, a liquid crystal display generally includes a driving circuit unit for driving a liquid crystal panel.

Referring to FIG. 1A, a conventional liquid crystal display comprises a X-PCB 2 having a column driver (that is, data driver IC) for supplying a data signal to a panel 1 thereon, a Y-PCB 4 having a row driver (that is, gate driver IC) for driving scan line (that is, gate electrodes in panel) thereon and a flexible Printed Circuit (FPC) 6 for connecting each PCB.

Thereafter, a method has been proposed that the FPC (6 of FIG. 1A) is removed, as shown in FIG. 1B. And, another method has been proposed that the Y-PCB (4 of FIGS. 1A and 1B) is removed and signals for driving gate driver IC are applied through signal line in the panel 1.

However, when the driving signal line of gate driver IC is formed in the panel 1, there are problems of voltage drop and skew of analog power supply.

Referring to FIG. 2, a plurality of gate driver IC 8 are formed on one side of panel 1 and the gate driver IC 8 is operated by driving signal line formed in the panel 1. In this case, analog power supply applied to the gate driver IC 8 has problems of voltage drop and voltage skew due to resistance R1, R2 and R3 in panel 1. According to a conventional method, analog power supply applied to the gate driver IC generates gate on/off currents by using DC/DC converter and charge pump circuit.

Therefore, voltage applied to a first gate driver IC has a problem of voltage drop corresponding to multiplied value of resistance R1 in panel and current of power supply terminal Irms and a problem of voltage skew corresponding to multiplied value of resistance R1 in panel and inrush current of power supply terminal Irush, thereby forming a waveform of A in FIG. 2.

Similarly, voltage applied to a second gate driver IC has a problem of voltage drop corresponding to multiplied value of resistance R1+R2 in panel and current of power supply terminal Irms and a problem of voltage skew corresponding to multiplied value of resistance R1+R2 in panel and inrush current of power supply terminal Irush, thereby forming a waveform of B in FIG. 2.

As mentioned above, voltage with different values is applied to each gate driver IC. In particular, gate turn-on voltage and turn-off voltage have direct influences on charge properties of liquid crystal display, thereby generating block and flicker between each gate driver IC.

That is, when signals are transmitted through PCB or FPC, voltage is supplied without skew of input power supply. However, when signals are applied to the gate driver IC 8 through the panel 1 without using PCB or FPC, skew is generated in signal, thereby lowering the screen quality.

In particular, when a gate pulse starts operation, current is instantaneously increased, thereby causing sudden voltage drop and voltage skew.

### SUMMARY OF THE INVENTION

Therefore, the present invention has been made to solve the above problems and an object of the present invention is to provide a liquid crystal display having remarkably improved screen quality by regularly supplying current applied to gate driver IC to reduce voltage drop and by correcting voltage skew to reduce voltage difference between gate driver IC, when a signal line is formed in panel to drive gate driver IC.

In order to accomplish the above object, the present invention comprises a gate driving power supply unit for supplying analog signal, a control circuit unit for applying control signal to analog signal outputted from the gate driving power supply unit; a correction circuit unit for applying control signal from the control circuit unit to correct analog signal outputted from the gate driving power supply unit into saw type; and a corrected power supply unit for supplying saw type signal corrected in the correction circuit unit to the gate driver IC.

According to the present invention, it is desirable that the saw type signal has the same cycle as gate pulse width and the correction circuit unit includes OP Amp or transistor. And, the gate driving power supply unit may include DC/DC converter having OP Amp or transistor. The OP Amp or transistor is formed only on gate turn-on line or both on gate turn-on line and gate turn-off line.

### BRIEF DESCRIPTION OF THE DRAWINGS

FIGS. 1A to 1C are drawings for showing a structure of general panel driving circuit unit.

FIG. 2 is a drawing for showing a waveform of voltage applied to gate driver IC through a signal line in panel according to a conventional method.

FIG. 3 is a block diagram for showing a gate driving circuit unit including saw type correction circuit according to the present invention.

FIG. 4 is a drawing for showing a waveform of input/output voltage of gate driver IC through the correction circuit of FIG. 3.

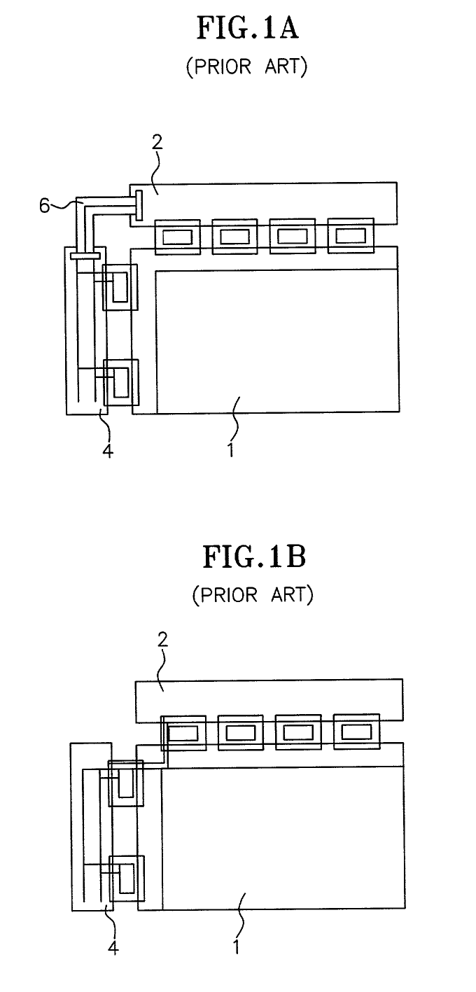

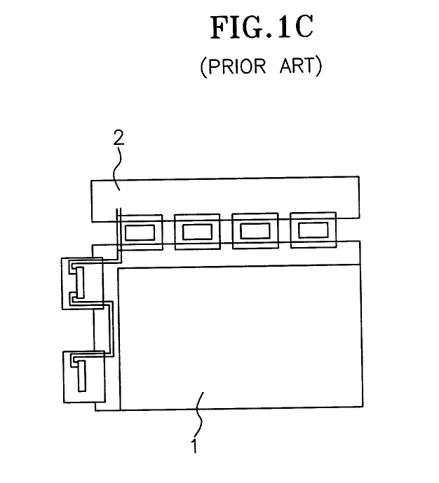

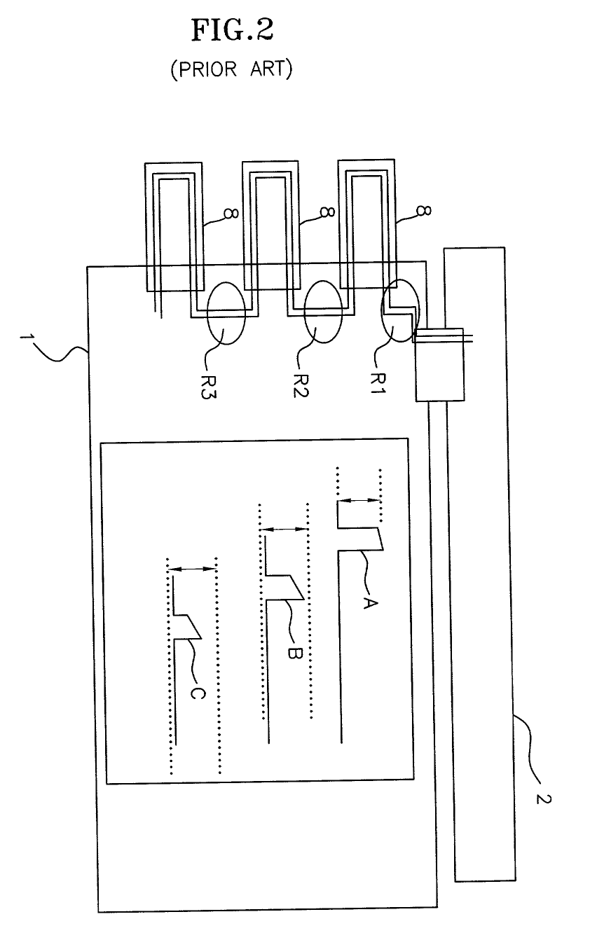

### DETAILED DESCRIPTION OF THE INVENTION

The above objects, and other features and advantages of the present invention will become more apparent after reading the following detailed description when taken in conjunction with the appended drawings.

According to the present invention, current applied to gate driver IC is regularly supplied in order to stably supply driving current of gate electrodes in panel (that is, scan line), thereby reducing voltage drop and at the same time, current is supplied in a saw type, thereby correcting voltage skew. Therefore, it is possible to minimize voltage difference between each gate driver IC.

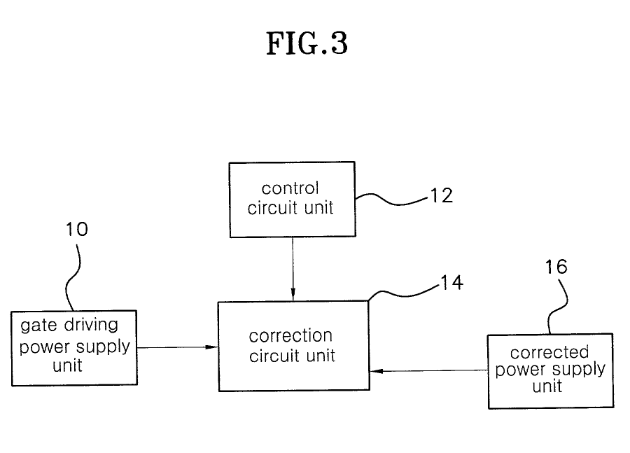

FIG. 3 is a block diagram for showing a gate driving circuit unit including a saw type correction circuit according to the present invention. Referring to FIG. 3, the gate driving circuit unit comprises a gate driving power supply unit 10 for supplying analog signal, a control circuit unit 12 for applying control signal to analog signal outputted from the gate driving power supply unit 10, a correction circuit unit 14 for applying control signal from the control circuit unit 12 and correcting analog signal outputted from the gate driving power supply unit 10 into a saw type, and a corrected power supply unit 16 for supplying saw type signal corrected in the correction circuit unit 14 to gate driver IC.

The saw type correction circuit unit 14 has a transistor (not shown) or OP-Amp (not shown) therein and a plurality of resistance and capacitors are connected to the OP Amp, thereby converting the output waveform of OP Amp into a desirable saw type. That is, the correction circuit unit 14 converts voltage waveform into a desirable saw type before current is applied to the corrected power supply unit 16 to drive gate electrodes in panel through gate driver IC.

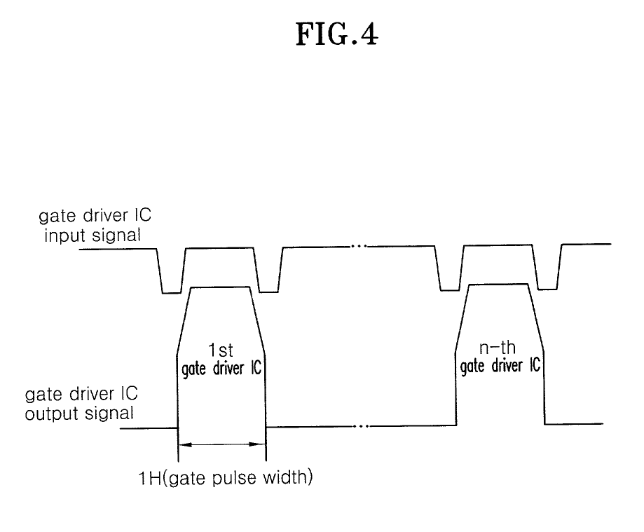

FIG. 4 is a drawing for showing a waveform of input/output voltage of gate driver IC through the correction circuit of FIG. 3. As shown in FIG. 4, input waveform of gate driver IC is converted into saw type through the correction circuit unit 14 of FIG. 3. Therefore, it is possible to minimize voltage difference in output waveform of each gate drive IC.

According to conventional method, voltage difference is generated between each gate driver IC, thereby causing voltage drop of analog power supply. However, according to the present invention, power is supplied in a saw type to correct voltage skew, thereby removing difference between each gate driver IC. Therefore, it is possible to generate the same voltage output. And, according to the present invention, the input voltage waveform of saw type has the same cycle as gate pulse width applied to gate electrode.

According to a preferred embodiment of the present invention, the OP Amp or transistor of the correction circuit unit is formed only on gate turn-on line or both on gate turn-on line and gate turn-off line.

And, according to another embodiment of the present invention, the gate driving power supply unit includes DC/DC converter having OP Amp or transistor. The OP Amp or transistor is also formed only on gate turn-on line or both on gate turn-on line and gate turn-off line.

As described above, according to the present invention, although a signal line is formed in panel to drive gate driver IC, current applied to gate driver IC is regularly supplied to reduce voltage drop and at the same time, current is supplied in a saw type to correct voltage skew, thereby minimizing voltage difference between each gate driver IC. As a result, it is possible to stably supply gate electrode driving current and remarkably improve screen quality of liquid crystal display and moreover, ensure reliability of product.

What is claimed is:

1. A liquid crystal display having a signal line in panel for driving gate driver IC, comprising:
a gate driving power supply unit for supplying analog signals;
a control circuit unit for applying control signal to analog signal outputted from the gate driving power supply unit;
a correction circuit unit for applying control signal from the control circuit unit to correct analog signal outputted from the gate driving power supply unit into a saw type; and
a corrected power supply unit for supplying saw type signals corrected in the correction circuit unit to the gate driver IC.

2. The liquid crystal display according to claim 1, wherein the saw type signal has the same cycle as the gate pulse width.

3. The liquid crystal display according to claim 1, wherein the correction circuit unit includes OP Amp or transistor.

4. The liquid crystal display according to claim 1, wherein the gate driving power supply unit includes DC/DC converter having OP Amp or transistor.

5. The liquid crystal display according to claim 3 or 4, wherein the OP Amp or transistor is formed on gate turn-on line.

6. The liquid crystal display according to claim 3 or 4, wherein the OP Amp or transistor is formed both on gate turn-on line and gate turn-off line.
